(19) United States
(12) Patent Application Publication
(10) Pub. No.: US 2021/0199816 A1
(43) Pub. Date: Jul. 1, 2021

(54) DEVICES AND METHODS FOR A DNA DOUBLE-STRAND-BREAK DOSIMETER

(71) Applicant: Board of Regents of the University of Texas System, Austin, TX (US)

(72) Inventors: Neil Kirby, San Antonio, TX (US); Eun Yong Shim, San Antonio, TX (US); Sang Lee, San Antonio, TX (US)

(21) Appl. No.: 16/075,013

(22) PCT Filed: Feb. 4, 2017
(86) PCT No.: PCT/US17/16619

§ 371 Date: Aug. 2, 2018

Related U.S. Application Data
(60) Provisional application No. 62/290,985, filed on Feb. 4, 2016.

(51) Int. Cl. G01T 1/10; G01T 5/02; G01T 7/00; B01L 3/00

(52) U.S. Cl. CPC G01T 1/10; G01T 5/02; B01L 2200/0668; B01L 3/502761; G01T 7/005

(57) ABSTRACT

Devices and methods for detecting radiation-induced cell damage by directly measuring DNA damage resulting from delivered radiation exposure is disclosed herein. The device can measure the rate of DNA double-strand break, which is the dominant factor for radiation induced cell damage. This approach enables more accurate measurements as compared to current exposure-based dosimetry. In embodiments, the device is comprised of magnetic streptavidin beads and strands of DNA configured with a biotin on one end and fluorescein on the other.

### FIELD OF THE INVENTION

The present invention relates generally to devices and methods for a dosimeter. More specifically, the present invention relates to devices and methods for detecting radiation-induced cell damage resulting from delivered radiation exposure.

### BACKGROUND OF THE INVENTION

Without limiting the scope of the disclosed devices and methods, the background is described in connection with devices and methods for detecting radiation-induced cell damage by directly measuring DNA damage resulting from delivered radiation exposure.

A dosimeter is a device that measures exposure to ionizing radiation. These devices are often utilized to protect humans from radiation exposure, as well as the measurement of radiation dose in applications such as medical and industrial. There are several types of dosimeters such as the electronic personal dosimeter (EPD), the film badge dosimeter, the quartz fiber dosimeter, and the thermo luminescent dosimeter (TLD). Each of these dosimeters relies on different mechanisms of action to obtain their measurements.

Known approaches in the art utilize an exposure-based approach. That is, the measurement of dose is based on delivered radiation exposure. This approach often requires calibration of machines/devices to correctly measure or estimate exposure to dose. For small, field doses, a set of correction factors are used on top of extrapolations from exposure to dose and then dose to biological damage.

As an example, in radiation therapy, ionizing radiation is used to shrink tumors and kill cancer cells by damaging the DNA within the actively replicating cancer cells. These procedures have traditionally involved treatment areas of 4 cm×4 cm and larger. The process for determining the resulting cellular damage involves using mathematical models specific to the radiation equipment and equipment calibration dosimeter to convert the machine output to an estimated biological cellular effect. Stereotactic radiation therapies, Stereotactic Radiosurgery (SRS) for treatment of brain tumors, and Stereotactic Body Radiotherapy (SBRT) for treatment of body tumors, target much smaller areas. These target areas are often at or below 1 cm×1 cm and some of the assumptions used in the models for larger fields do not accurately reflect the delivered dose. This is particularly critical in SRS, which uses very small field sizes and requires accuracy of 1-2 mm. What is desired therefore, is a dosimeter that circumvents the calculated connections between exposure, dose, and biological damage with one that directly measures DNA damage resulting from delivered radiation. The measured DNA damage would now directly correlates with the biological cellular effect allowing for more accurate delivery of the intended dose.

In view of the foregoing, it is apparent that there exists a need in the art for a device and method to directly measure biological damage resulting from delivered radiation exposure, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for devices, systems, and methods directed to a dosimeter.

In one embodiment, the device is comprised of magnetic streptavidin beads and strands of DNA configured with a biotin on one end and fluorescein on the other end. The biotin causes the DNA strand to adhere to the magnetic streptavidin bead. The configured DNA strand adhered to the magnetic streptavidin bead will be referred to as the marker element. In embodiments, the device is further comprised of a solution element and a body element. The marker elements are held in the solution element that is held by the body element. In embodiments, the solution element is a physiological solution.

The DNA dosimeter or device in embodiments is utilized using the following steps: the DNA dosimeter or device is measured with a fluorescence reader prior to being radiated. The measured fluorescence will serve as the baseline. The DNA dosimeter or device produces a signal that is proportional to the number of configured DNA strands held in the body element. The DNA dosimeter or device is then radiated. A magnet is then placed up against the body element and the contents within the body element are then washed. The magnetic streptavidin beads stick to the magnet and remain in the body element. If a double strand break has occurred for a DNA strand, the attached fluorescein is washed away. Thus, when the fluorescence of the DNA dosimeter or device is read after the delivered radiation exposure, the amount fluorescence amount removed from the original signal is proportional to the probability of a double strand break.

In summary, the present invention discloses devices, systems, and methods directed to a dosimeter. More specifically, the present invention relates to devices, systems, and methods for detecting radiation-induced cell damage by directly measuring DNA damage resulting from delivered radiation exposure.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is an illustration of the DNA double-strand-break dosimeter device in accordance with the teachings of the present disclosure;

FIG. 2 is a plot illustrating measured probability of double strand breaks versus delivered radiation dose in accordance with the teachings of the present disclosure.

### DETAILED DESCRIPTION OF THE INVENTION

Disclosed herein are devices, systems, and methods directed to detecting radiation-induced cell damage by directly measuring DNA damage resulting from delivered radiation exposure. The numerous innovative teachings of the present invention will be described with particular reference to several embodiments (by way of example, and not of limitation).

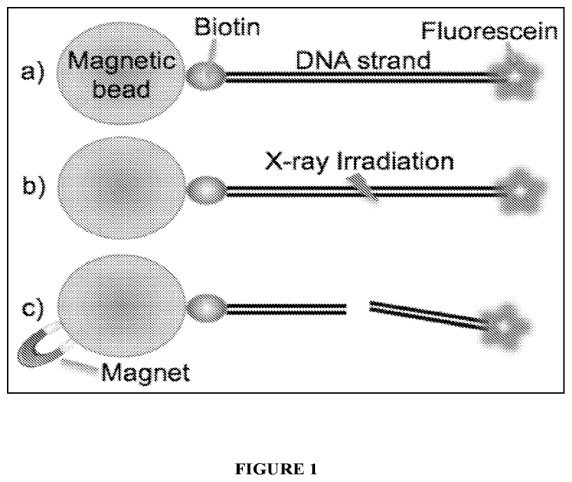

Reference is first made to FIG. 1, an illustration of the DNA double-strand-break dosimeter device in accordance with the teachings of the present disclosure. In one embodiment, the device is comprised of magnetic streptavidin beads and strands of DNA configured with a biotin on one end and fluorescein on the other end. In embodiments, the magnetic streptavidin beads are Dynabeads® M-280 streptavidin having a bead diameter of 2.8 μm, a concentration of 10 mg/ml, iron content (ferrites) of twelve percent, a specific surface area of 4-8 m²/g, and a density of 1.4 g/cm³. In embodiments, the biotin has the oligo name Biotin-pRS316, sequence ttccatggagggcacagttaagccg, synthesis scale 50 nmol, five prime Biotin, and purification salt-free. In embodiments, the fluorescence has the oligo name FAM-pRS316, sequence atcaagagctaccaactctttttccg, synthesis scale 50 nmol, five prime FAM, and purification salt-free. The biotin causes the DNA strand to adhere to the magnetic streptavidin bead. The configured DNA strand adhered to the magnetic streptavidin bead will be referred to as the marker element. This is shown in FIG. 1A. In embodiments, the DNA length and concentrations may vary dependent on the application. In embodiments, the DNA length is 4 kb base pairs. The length of the DNA strand affects the binding capacity of the streptavidin. As one skilled in the art may appreciate, the longer DNA length strands are more likely to break with the exposed radiation dose. That is the probability of a double strand break for the DNA increases as the length of the DNA increases. A response and breaks can be achieved at doses much lower with 4 kb DNA than smaller DNA lengths. In addition, the bead size may vary depending on the application. In embodiments, the device is further comprised of a solution element and a body element. The body element is a structure that holds the contents of the solution element and the marker element and is configured to allow the steps to be performed as disclosed herein. That is the marker elements are held in the solution element that is held or contained in the body element. In embodiments, the solution element is a physiological solution. In embodiments, the body element is 1.5 ml tube. In other embodiments, the body element is a capillary tube.

The DNA dosimeter or device in embodiments is utilized using the following steps: the DNA dosimeter or device is measured with a fluorescence reader prior to being radiated. The measured fluorescence will serve as the baseline. The DNA dosimeter or device produces a signal that is proportional to the number of configured DNA strands held in the body element. The DNA dosimeter or device is then radiated. This is shown in FIG. 1B. A magnet is then placed up against the body element and the contents within the body element are then washed. In embodiments, a DynaMag™-2 magnet by Life Technologies is used. The magnetic streptavidin beads stick to the magnet and remain in the body element. If a double strand break has occurred for a DNA strand, the attached fluorescein is washed away. This is shown in FIG. 1B. Thus, when the fluorescence of the DNA dosimeter or device is read after the delivered radiation exposure, the amount of fluorescence removed from the original signal is proportional to the probability of a double strand break. In embodiments, other measurements may be taken such as reading the fluorescence after irradiation of the washed beads and also of the supernatant, or component that is washed away.

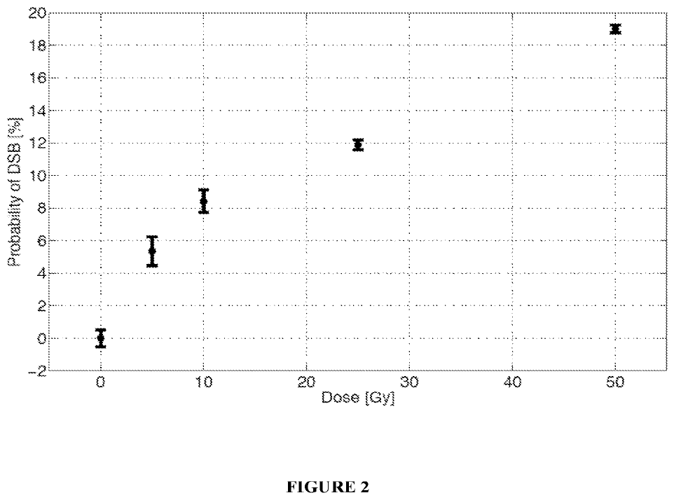

Reference is next made to FIG. 2, a plot illustrating measured probability of double strand breaks versus delivered radiation dose in accordance with the teachings of the present disclosure. Illustrated in this figure is as the dose is increased, the probability of double strand breaks increases.

### Example 1

The following is illustrative of the method and steps for the preparation of a 400 μL sample of the DNA dosimeter at regular concentration.

PCR Setup (400 μL)
1. dH₂O 334.4 μL (the first step)
2. Accu PCR buffer (I) 40 μL (Stored in the freezer) (thaw, vortex, and spin)
3. Biotin (Diluted 1/10=10 pmole/μL) 4 kb 5′ 8 μL (Stored at 4° C.) (vortex)
4. FAM (Diluted 1/10=10 pmole/μL) 3′ 8 μL (Stored at 4° C.) (vortex
5. PRS 316 8 μL (Stored in the freezer=10 or 20 ng/μL) (thaw, vortex, and spin)
6. Accu prime Taq 1.6 μL (the last step)(Stored in the freezer) (thaw, vortex, and spin)
7. Vortex and spin the mixture
8. Place each 50 μL of this mix in 8 PCR tubes
9. Spin the PCR tubes again
10. Incubate for 3 hours and 16 minutes in the PCR machine
a. 94° C. 15 s
b. 94° C. 15 s
c. 55° C. 15 s>>>>>>>>>>>>>>>>>2, 3, and 4 repeated (34) times
d. 68° C. 4 m
e. 68° C. 5 m
f. 12° C. ∞

During all steps we should keep all materials in ice.
11. Materials stored in freezer must be thawed before pipetting by keeping the material at room temperature for few minutes as frozen samples cannot pipette. The need for using the vortex and spinner is because the material should be as homogenous as possible, so each time we pipette a sample from the material it has the same density, which makes the PCR setup very reproducible by getting almost the same concentration of DNA strands.

Running the Gel
1. Take 1.5 μL of PCR product and dilute it with 13.5 μL of dH₂O (PCR diluted 1/10)
2. Check the type of gel if it fits the 4 kb (different types of gel are used for different
PCR sizes—1% agarose)
3. Run 3 μL of size marker (1 kb)
4. Run 3 μL of elution buffer+4 μL of PCR diluted product+1 μL of loading dye
5. Run 3 μL of elution buffer+10 μL of PCR diluted product+1 μL of loading dye
6. Wait for 40 min
7. Check the gel (to find the length and concentration of PCR product)

Attaching the Beads (Immobilization Procedure—100 μL of PCR+100 μL of Beads)
1. Place 100 μL of beads on the magnet (2 min)
2. Discard supernatant while tube remains on the magnet
3. Wash once with binding solution (200 μL)
4. Re-suspend beads in 200 μL binding solution (no need to mix it)
5. Add 100 μL of PCR to 100 μL of dH₂O (total volume is 200 μL)
6. Add (d) to (e) (no need to mix it)
7. Incubate at room temperature for (3 hours) on a roller while covered with aluminum foil.
8. Place the tube on the magnet (2 min), take supernatant (put it in a new tube)
9. Wash the beads twice with 500 μL washing solution
10. Wash the beads once with 500 μL elution buffer
11. Re-suspend the beads in 200, 400, 800 μL of PBS to get X2 concentrated, regular, and X2 diluted dosimeter, respectively.

Regular concentration is the concentration of the DNA double-strand-break dosimeter. It has been shown that using a more concentrated dosimeter might increase the signal to noise ratio and the response at low doses.

Checking the Fluorescence

Dilute both beads and supernatant with a factor of 50 (1 μL B/S+49 μL dH₂O)

Place 25 μL of the supernatant+6 μL of Binding buffer+19 μL of PBS in the 1st well.

Place 25 μL of the beads+25 μL of binding buffer in the 2^{nd} well.

Place 50 μL of PBS in the 3^{rd} well.

$$Efficiency = \frac{( B - BG )}{[ ( S - BG ) + ( B - BG ) ]}$$

where. B is the fluorescence of the dosimeter (the beads attached to DNA strands).
   BG is the fluorescence of a well where 50 μL of PBS in (step d) was placed, we call it background.
   S is the fluorescence of the supernatant

In embodiments, the streptavidin beads are opaque. Opacity affects the efficiency of reading the fluorescence signal of the DNA strands, which attach to the beads. In embodiments, the binding efficiency may also be calculated in the following manner. During the immobilization procedure, the PCR product is attached to the streptavidin beads. The PCR represents the total number of DNA double strands attempting to attach, while the supernatant in the immobilization procedure represents the number of DNA double strands which did not attach to the beads. Theoretically, the subtraction of PCT and supernatant fluorescence signals will represent the number of DNA double strands attached to the streptavidin beads. It is recommended to read at least 50 μL in each plate well for more precise readings, but reading high volumes of PCR will oversaturate the response. In embodiments smaller volumes of both PCR and supernatant are utilized to calculate binding efficiency. These small volumes represent equivalent volumes and ratios to what was used during the immobilization procedure. The PBS buffer was used for dilution purposes and to achieve a volume of 50 μL in each plate well.

To calculate the binding efficiency, in an embodiment, the following steps are taken:

In a first well, place is 1 μL of PCR product diluted with 49 μL of PBS (PCR).

In a second well, placed is 4 μL of supernatant diluted with 46 μL of PBS (S).

In a third well. placed is 50 μL of PBS for the background signal (BG).

$$Binding Efficiency = \frac{PCR - S - 2 BG}{PCR - BG}$$

The disclosed devices, systems, and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the disclosed devices, systems, and methods for measuring shallow skin doses as well as any organization concerned with the impact a new drug could have in regards to DNA damage. Consequently, any embodiments comprising a one piece or multi piece system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” “consisting essentially of,” respectively, shall be closed or semi-closed transitional phrases.

The devices, systems, and/or methods disclosed and claimed herein can be made and executed without undue experimentation in light of the present disclosure. While the devices, systems, and methods of this invention have been described in terms of preferred embodiments, it will be apparent to those skilled in the art that variations may be applied to the devices, systems, and/or methods and in the steps or in the sequence of steps of the methods described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

### REFERENCES

1. National Cancer Institute. Radiation Therapy for Cancer, <http://www.cancer.gov/about-cancer/treatment/types/radiation-therapy/radiation-fact-sheet#q1>(
2. News Medical AZO Network. Radiation Therapy Mechanism, <http://www.news-medical.net/health/Radiation-Therapy-Mechanism.aspx>(
3. MedScape WebMD. General Principles of Radiation Therapy, <http://emedicine.medscape.com/article/846797-overview#a1>(
4. Das, I. J., Ding, G. X. & Ahnesjo, A. Small fields: Nonequilibrium radiation dosimetry. Medical physics 35, 206-215, doi:doi:http://dx.doi.org/10.1118/1.2815356 (2008).
5. Ahnesjo, A. & Aspradakis, M. M. Dose calculations for external photon beams in radiotherapy. Physics in Medicine and Biology 44, R99 (1999).
6. Das, I., Downes, M. B., Kassaee, A. & Tochner, Z. Choice of Radiation Detector in Dosimetry of Stereotactic Radiosurgery-Radiotherapy. Journal of Radiosurgery 3, 177-186, doi:10.1023/A:1009594509115 (2000). Massillon, J. L. G., Cueva-Procel, D., Diaz-Aguirre, P., Rodriguez-Ponce, M. & Herrera-Martinez, F. Dosimetry for small fields in stereotactic radiosurgery using gafchromic MD-V2-55 film, TLD-100 and alanine dosimeters. PloS one 8, e63418, doi:10.1371/journal.pone.0063418 (2013).
8. Benedict, S. H. et al. Stereotactic body radiation therapy: the report of AAPM Task Group 101. Medical physics 37, 4078-4101 (2010).
9. Radiology Society of North America. Stereotactic Radiosurgery (SRS) and Stereotactic Body Radiotherapy (SBRT), <http://www.radiologyinfo.org/en/info.cfm?pg=stereotactic>(
10. Schuch, A. P., Lago, J. C., Yagura, T. & Menck, C. F. DNA dosimetry assessment for sunscreen genotoxic photoprotection. PloS one 7, e40344, doi:10.1371/journal.pone.0040344 (2012).
11. Wilhelm, S. W. et al. UV radiation induced DNA damage in marine viruses along a latitudinal gradient in the southeastern Pacific Ocean. Aquatic Microbial Ecology 31, 1-8, doi:10.3354/ame031001 (2003).
12. Chen, W., Blazek, E. R. & Rosenberg, I. The relaxation of supercoiled DNA molecules as a biophysical dosimeter for ionizing radiations: a feasibility study. Medical physics 22, 1369-1375 (1995).
13. Park, D. G., Song, H., Lee, D. & Jeong, Y. H. Method for detection of radiation-induced damage to biomaterial using magnetic sensor and magnetic sensor biochip for biodosimetry using the same. (2013).
14. SeekingAlpha. Varian Medical Systems: Fighting the Global Cancer Burden, <http://seekingalpha.com/article/411141-varian-medical-systems-fighting-the-global-cancer-burden>(
15. ASTRO: American Society for Radiation Oncology. Fast Fact About Radiation Therapy, <https://www.astro.org/News-and-Media/Media-Resources/FAQs/Fast-Facts-About-Radiation-Therapy/Index.aspx>(
16. Imaging Technology News/Scranton Gillette Communications. State of the Industry: Radiation Therapy, <http://www.itnonline.com/article/state-industry-radiation-therapy>

What is claimed is:

1. A device for a DNA double-strand-break dosimeter comprising:
magnetic streptavidin beads; and
strands of DNA configured with biotin on one end and fluorescein on the other end.

2. The device of claim 1, further comprising a solution element and a body element.

3. The device of claim 2, wherein said solution element is a physiological solution.

4. The device of claim 2, wherein said body element is a 1.5 ml tube.

5. The device of claim 2, wherein said body element is a capillary tube.

6. The device of claim 1, wherein said magnetic streptavidin beads are Dynabeads® M-280 streptavidin.

7. The device of claim 1, wherein said magnetic streptavidin beads have a bead diameter of 2.8 μm, a concentration of 10 mg/ml, iron content (ferrites) of twelve percent, a specific surface area of 4-8 m²/g, and a density of 1.4 g/cm³.

8. The device of claim 1, wherein said biotin has the oligo name Biotin-pRS316, sequence ttccatggagggcacagttaagccg, synthesis scale 50 nmol, five prime Biotin, and purification salt-free.

9. The device of claim 1, wherein said fluorescein has the oligo name FAM-pRS316, sequence atcaagagctaccaactctttttccg, synthesis scale 50 nmol, five prime FAM, and purification salt-free.

10. The device of claim 1, wherein said magnetic streptavidin beads have a bead diameter of 2.8 μm, a concentration of 10 mg/ml, iron content (ferrites) of twelve percent, a specific surface area of 4-8 m²/g, and a density of 1.4 g/cm³; said biotin has the oligo name Biotin-pRS316, sequence ttccatggagggcacagttaagccg, synthesis scale 50 nmol, five prime Biotin, and purification salt-free; and said fluorescein has the oligo name FAM-pRS316, sequence atcaagagctaccaactctttttccg, synthesis scale 50 nmol, five prime FAM, and purification salt-free.

11. The device of claim 2, wherein said magnetic streptavidin beads are Dynabeads® M-280 streptavidin.

12. The device of claim 2, wherein said magnetic streptavidin beads have a bead diameter of 2.8 μm, a concentration of 10 mg/ml, iron content (ferrites) of twelve percent, a specific surface area of 4-8 m²/g, and a density of 1.4 g/cm³.

13. The device of claim 2, wherein said biotin has the oligo name Biotin-pRS316, sequence ttccatggagggcacagttaagccg, synthesis scale 50 nmol, five prime Biotin, and purification salt-free.

14. The device of claim 2, wherein said fluorescein has the oligo name FAM-pRS316, sequence atcaagagctaccaactctttttccg, synthesis scale 50 nmol, five prime FAM, and purification salt-free.

15. The device of claim 2, wherein said magnetic streptavidin beads have a bead diameter of 2.8 μm, a concentration of 10 mg/ml, iron content (ferrites) of twelve percent, a specific surface area of 4-8 m²/g, and a density of 1.4 g/cm³; said biotin has the oligo name Biotin-pRS316, sequence ttccatggagggcacagttaagccg, synthesis scale 50 nmol, five prime Biotin, and purification salt-free; and said fluorescein has the oligo name FAM-pRS316, sequence atcaagagctaccaactctttttccg, synthesis scale 50 nmol, five prime FAM, and purification salt-free.

16. A method of use for a DNA double-strand-break dosimeter device comprising the steps of:
the DNA dosimeter device is measured with a fluorescence reader prior to being radiated;
the DNA dosimeter device is radiated;
a magnet is placed against the body element of the DNA double-strand-break dosimeter;
the contents within the body element are washed;
the DNA dosimeter device is measured with a fluorescence reader.

17. The method of claim 16, further comprising the step of the supernatant is measured with a fluorescence reader.

18. The method of claim 16, wherein said magnet is a DynaMag™-2 magnet.
